(19) United States
(12) Patent Application Publication
(10) Pub. No.: US 2025/0010230 A1
(43) Pub. Date: Jan. 9, 2025

(54) HYBRID NANOPOROUS MEMBRANE ASSEMBLED FROM 3D NANOSPIKY PARTICLES FOR ENVIRONMENTAL AND BIOLOGICAL APPLICATIONS

(71) Applicant: THE TRUSTEES OF COLUMBIA UNIVERSITY IN THE CITY OF NEW YORK, New York, NY (US)

(72) Inventors: Kam W. LEONG, New York, NY (US); Letao YANG, New York, NY (US)

(21) Appl. No.: 18/890,591

(22) Filed: Sep. 19, 2024

Related U.S. Application Data
(63) Continuation of application No. PCT/US2023/015968, filed on Mar. 22, 2023.
(60) Provisional application No. 63/322,339, filed on Mar. 22, 2022.

(51) Int. Cl. B01D 39/20; A41D 13/11; B01D 39/16

(52) U.S. Cl. CPC B01D 39/2031; A41D 13/1192; B01D 39/1615; B01D 39/1623; B01D 2239/025; B01D 2239/0258; B01D 2239/0442; B01D 2239/065

(57) ABSTRACT

The hybrid nanoporous membranes are assembled from inorganic 3D nanospiky particles and polymers, and can be used to filter, capture, and manipulate environmental or biological substances. These materials provide efficient, continuous filtration of ultrasmall biological substances with sizes less than 100 nm while still maintaining air or fluid flow through the materials.

### REFERENCE TO RELATED APPLICATIONS

This application is a continuation of International Application No. PCT/US2023/015968, filed Mar. 22, 2024, which claims priority to U.S. Provisional Application No. 63/322,339, filed Mar. 22, 2022, entitled “Hybrid Nanoporous Membrane Assembled from 3D Nanospiky Particles for Environmental and Biological Applications”; the contents of which are incorporated herein by reference in its entirety.

### TECHNICAL FIELD

The present invention relates to hybrid nanoporous filtration membranes containing nanospiky particles.

### BACKGROUND

Porous membranes are used for filtration in a wide variety of fields, but these membranes tend to clog or collapse during use, resulting in compromised flow through the membrane. Multifunctional nanoporous membranes that can filter, capture, and manipulate environmental/biological substances such as atmospheric aerosol particles, viruses, bacteria, extracellular vesicles, and cancer cells, are widely used in healthcare products. Exemplary products include face masks, hemodialysis machines, wound dressings, cell culture apparatus, and cancer diagnostic devices. Most current membranes for filtration applications are based on polymeric composites such as polycaprolactone nanofibers, cellulose and polyvinylidene fluoride membranes.

To achieve both high filtration efficiency and high air/liquid flow, however, remains a critical challenge for polymer-based porous membranes. One immediate example is that very few masks in the market can completely prevent the transmission of SARS-CoV-2 virus, and these masks are usually extremely expensive (>10 and 100 times more expensive than N95 and surgical masks, respectively), and often show compromised air flow.

Another challenge of conventional polymeric membranes is their sub-optimal biological functions required in special biomedical applications. Hybridizing micro/nano particles (e.g., antimicrobial silver nanoparticles) into polymeric composites has been a commonly adapted strategy for enhancing biological functions such as antiviral performance of nanoporous membranes.

The biological functions of micro/nano particles, however, are frequently compromised in the polymeric composites. A technology platform that generates nanoporous membranes with high filtration efficiency and efficient air/liquid flow, while dynamically integrating biological functions, bridges these gaps with a wide range of uses.

### SUMMARY

The present disclosure in aspects and embodiments addresses the various needs and problems related to multifunctional nanoporous membranes that can filter, capture, and manipulate environmental/biological substances such as atmospheric aerosol particles, viruses, bacteria, extracellular vesicles, and cancer cells, are widely used in healthcare products.

### DESCRIPTION OF THE EMBODIMENTS

In one embodiment, the present subject matter provides a hybrid nanoporous membrane comprising a polymer layer and a 3D nanospiky particle layer, where the 3D nanospiky particle layer comprises particles comprising gold, silver, iron oxides, manganese oxides, titanium oxides, nickel, silica, silicon, zinc oxides, carbon, or any combination thereof. In another embodiment, the 3D nanospiky particle layer comprises manganese oxide, manganese dioxide, or a combination thereof. In another embodiment, the manganese oxide or manganese dioxide is silver-doped. In another embodiment, the polymer layer comprises nanofibers. In yet another embodiment,

In another embodiment, the 3D nanospiky particles have 1-100 nm interstitial space. In another embodiment, the 3D nanospiky particles comprise at least 4 spikes. In another embodiment, the 3D nanospiky particles comprise over 5000 spikes. In yet another embodiment, each spike ranges from 5 nm to 100 μm in length.

In another embodiment, the tip diameter of each spike ranges from 0.5 nm to 100 nm.

In another embodiment, the polymer comprises one or more of polycaprolactone, poly lactic co-glycolic acid, chitosan, cellulose-derivatives, polytetrafluoroethylenes, nylon, and polycarbonates.

In another embodiment, the membrane is useful for filtering or inhibiting one or more of the following: microorganisms, viruses, and other biological substances, or other environmental contaminants. In another embodiment, the one or more environmental or biological substances comprises one or more of the following: atmospheric aerosol particles, viruses, bacteria, fungi, extracellular vesicles, and cancer cells.

In another embodiment, the membrane further comprises one or more active ingredients effective to neutralize or treat one or more of the environmental or biological substances.

Another embodiment provides a method of providing filtration comprising use of any of the above hybrid nanoporous membranes.

Another embodiment provides a filtration device comprising any of the above hybrid nanoporous membranes. In another embodiment, the filtration device comprises one or more of the following: a face mask or other air and fluid filters for filtering or inhibiting biological contaminants, an air pollution filter, a cell culture substrate, a wound dressing, a hemodialysis membrane, a gauze or scaffold used for organ transplantation with scavenging capability, a vessel graft, and a tumor insert.

Another embodiment provides a method of providing filtration comprising use of any of the above filtration devices.

### BRIEF DESCRIPTION OF THE DRAWINGS

FIG. 1 presents an example of an air mask and illustrates the trapping of virus particles by the nanofiber layer and Nanospiky particles (microbur) layer.

FIG. 2 illustrates one example of use of nanofibers in masks.

FIG. 3 shows construction of a filter with adjacent layers of microfiber and Nanospiky particles. An image of the interface of the layers is presented in the left image, a magnified view of the interface of the layers is presented in the middle image, and a magnified view of the Nanospiky particles with trapped model viral particles is presented in the right image.

FIG. 4 presents images and structures of constructions comprising nanofiber and Nanospiky particle layers.

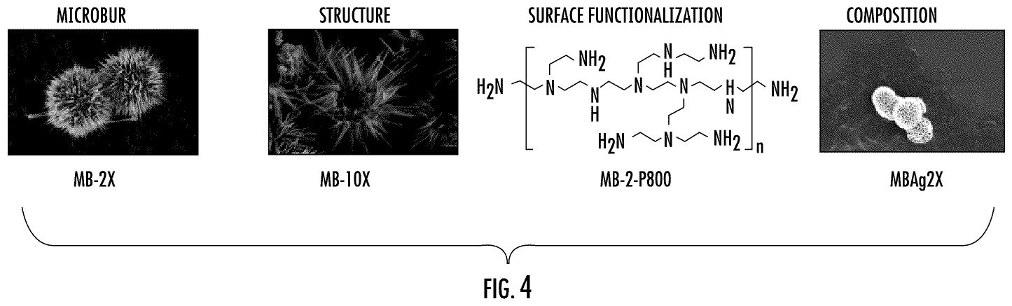

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to certain embodiments of the present subject matter.

### DETAILED DESCRIPTION

The disclosure concerns a hybrid nanoporous membrane that can be layer-by-layer assembled from inorganic 3D nanospiky particles and polymers. In some embodiments, the hybrid nanoporous membranes comprise alternating layers of polymer and inorganic spiky nanoparticles. The spikes of these nanoparticles create rigid interstitial spaces, which allow for the filtration of ultra-fine particles without compromising fluid flow. These spiky particles are also able to capture and manipulate the substances being filtered, further enhancing the biological functionality of the membrane. As such, this technology may be useful in filtering and inhibiting microorganisms and viruses in products such as facemasks, wound dressings, and hemodialysis membranes, as well as in cell culture substrates and vessel grafts.

The nanospikes create rigid pores in the membrane, which allow small particles to be filtered, while maintaining fluid flow. These nanospike particles are also able to capture and manipulate particles, enhancing the overall biological function of the membrane. As such, this technology may be useful in filtering and inhibiting microorganisms and viruses in products such as facemasks and wound dressings, as well as in cell culture substrates and vessel grafts.

One major innovation of the disclosure is the creation of rigid, nanoscale (1-100 nm) interstitial spaces within 3D nanospiky particles and their assemblies that supports 3D air/fluid flow and efficient, continuous filtration of ultrasmall (<100 nm) biological substances such as virus and exosomes. Although there are several membranes on the market that can also filter sub-100 nm particles, they are typically based on flexible polymeric structures that conform under pressure, which can impede air/liquid flow. For example, even N95 face masks, designed for filtering sub-micron particles, still require an air valve to facilitate the breath and air flow—a feature not required by the instant disclosure.

In contrast to commercial products, inorganic 3D nanospiky particles with rigid, 3D nanoporous structures continuously support air/liquid flow even after capturing the biological substances, thereby improving the filtration performance of the hybrid nanoporous membrane.

Additionally, the 3D nanospiky structures, after capturing, can exert mechanical forces on the biological substances, thereby providing additional biological functions to the membrane. Further, polymer layers act as a flexible support to endow mechanical compliance of the membrane. By doing so, we introduce a membrane product that has high filtration efficiency, efficient air/liquid flow after particle capturing, while dynamically integrating nanospike-enhanced biological functions.

The instant membranes can be assembled from one layer of polymer film and one layer of 3D nanospiky particles; it can also be assembled from multiple alternating layers of polymer films and 3D nanospiky particles including one thousand layers of polymer films and one thousand 3D nanospiky particles. The ratio between polymer layer number and particle layer number can be anywhere from 1:1 to 1000:1, and each polymer layer can contain same or different polymers and structures.

In certain embodiments, the thickness of each polymer and particle layer can be as small as 10 nm, and as large as 1 cm. The polymer layer can be nanofiber, microfiber, or any other nanoporous membrane construction. In some embodiments, the polymer layers can be composed of polycaprolactone, poly lactic co-glycolic acid, chitosan, cellulose-derivatives, polytetrafluoroethylenes, nylon, polycarbonates, or a combination thereof.

The 3D nanospiky particles can range from 10 nm to 100 μm, including 1-5 μm. The 3D nanospiky particles can be composed of any suitable material including gold, silver, iron oxides, manganese oxides (such as manganese oxide and manganese dioxide), titanium oxides (such as titanium dioxide and titanium monoxide), nickel, silica, silicon, zinc oxides (such as ZnO), carbon, pollens, and doped with other elements.

The number of spikes in each particle can range from 4 spikes to over 5000 spikes. The length of each spike can range from 5 nm to 100 μm. The tip diameter of each spike can range from 0.5 nm to 100 nm. In certain embodiments, the nanoparticle may or may not have a hollow core, and its shape can range from 0D spheres, 1D rods, to 2D sheets, while the spikes are vertical (60 degrees to 90 degrees) to the surfaces of particles. Nanomaterials are typically categorized as zero-dimensional (0D) (such as nanoparticles), one-dimensional (1D) (such as nanotubes and nanorods), two-dimensional (2D) (such as sheets such as graphene), and three-dimensional (3D) (for example, nanoflowers and nanoprisms).

In one specific example, we layer-by-layer assembled 1-5 μm manganese dioxide, with or without silver doped, 3D nanospiky particles on polycaprolactone nanofibers using a vacuum filtration method. The spikes, for example, comprised manganese oxide (MnO) or manganese dioxide (MnO₂), with or without silver doping.

As used herein, the terms “Nanospiky particle” and “microbur” are used interchangeably.

These filters can capture and manipulate almost any type of nanoscale biological substances, providing a broad range of applications.

Applications of the instant filters include a wide range of uses. These applications include, but are not limited to, use in face masks and other air and fluid filters for filtering and inhibiting bacteria, virus, fungi, and other microorganisms; cell culture substrates; wound dressings for promoting tissue regeneration and preventing infections; hemodialysis membranes; gauzes or scaffolds used for organ transplantation with scavenging capabilities; vessel grafts; and tumor inserts. In other embodiments, the membranes can be used for face masks, wound dressings, and air pollution filters. Yet other embodiments concern use in hemodialysis membranes, cell culture substrate, and biosensors.

In some embodiments, nanoparticle comprises manganese oxide, which may be synthesized by using a manganese compound (e.g., manganese acetate) and an acid (e.g., tannic acid) at high temperature (e.g., 100-150° C.). First, in 50 mL plastic centrifuge tubes, prepare aqueous solutions of Mn(CH₃COOH)₂·4H₂O at a concentration of 3.65 g per 200 mL and (NH₄)₂S₂O₈ at a concentration of 3.90 g per 200 mL, which is enough for 10 reactions (40 mL total volume for each reaction). Then at room temperature, 20 mL Mn(CH₃COOH)₂·4H₂O was added to 20 mL (NH₄)₂S₂O₈ drop by drop under vigorous stirring at 1200 rpm for 10-20 minutes until the solution become pale yellow. Following that 1.6 mL concentrated sulfuric acid (H₂SO₄, 95-98%) was added into the yellow solution. The solution was continued to stir for 10 minutes. The solution was transferred to a 40 mL hydrothermal chamber and heated from room temperature to 120° C. within 30 minutes, followed by continuous heating at 120 degrees for 5 hours. Then the microburs (black-colored precipitates) were washed with water and ethanol for 2 times each, until the pH become neutral (pH=7). After freeze drying, the microburs can be harvested and weighed for biomedical applications.

To dope the microburs with different amounts of silver, aluminum, iron, and other ions, typically their nitrate salts with varying amount were added together with Mn(CH₃COOH)₂·4H₂O before their reaction with (NH₄)₂S₂O₈. To modulate the size, shape, and structure of microbur, concentrations of precursors, temperature and heating time were altered. As another example, a mixture of manganese acetate and tannic acid with a mass ratio of manganese acetate and tannic acid of 1:2-6 may be prepared in Milli-Q® ultrapurified water and stirred for 10 minutes at room temperature. The mixture solution may then be transferred into an autoclave. After heat treatment for 2 hours, the sample solution is cooled to less than 50° C. naturally.

In an alternative embodiment, the MnO nanoparticles may be made from a manganese compound, an acid and a solvent, where the manganese compound and acid are mixed for at least 1 minute with the solvent, and then heated at a temperature of a range of about 90° C. to about 175° C. for at least 1 hour, and then cooled naturally to at least 50° C.

It should be understood that the manganese compound may be any suitable manganese compound, including but not limited to manganese phosphate, manganese oxide, manganese acetate, manganese sulfide, manganese dioxide, manganese heptoxide, manganese chloride, manganese carbonate, and the like. It should be understood that any suitable type of acid may be used. Additionally, it should be understood that any suitable type of solvent may be used. As a non-limiting example, water may be the solvent.

Further, it should be understood the mixing of the manganese compound, acid, and solvent may be performed for any suitable time period, such as between, for example, 0.5 minutes and 5 minutes.

Other metal oxide nanostructures, such as nickel oxides, germanium oxides, vanadium oxides, aluminum oxides, iron oxides, manganese oxides, titanium oxides, and zinc oxides, can be made by analogous methods to those described above or other methods known to those skilled in the art. As an example, zinc oxide with the 3D nanospiky microbur shape has been made by following methods. By first preparing solutions of NaOH-0.64 g in 4.0 mL water, and Zn(CH₃COOH)₂·2H₂O-0.36 g in 4.0 mL water, the two solutions were then mixed rapidly for 10-60 minutes. The clear solution was then transferred to glass vial sealed by parafilm.

After incubation of the glass vial at 40° C. for 1, 2, 4, 8, 12, 24, and 48 hours, ZnO microburs with different shapes were synthesized. Typically longer reaction time resulted in longer needles. The synthesized ZnO microburs were washed for 3 times using water and centrifuge then the microburs were dried in 90° C. overnight to obtain the final product.

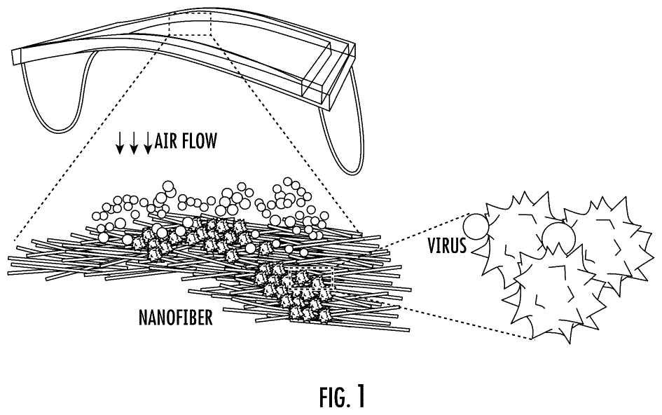

In one embodiment, the disclosure concerns air masks. One such example is shown in FIG. 1. Nanofibers are used for mechanical compliance and primary filtration. The Nanospiky particles provide nanoscale interstitial space for virus and/or bacterial capture. In some embodiments, the virus and/or bacteria are killed in situ. In certain embodiments, the masks are constructed from easy to degrade or recyclable materials. While the illustration is of a mask that can be used for environmental and biological applications, the concept is generally applicable to other filtration situations.

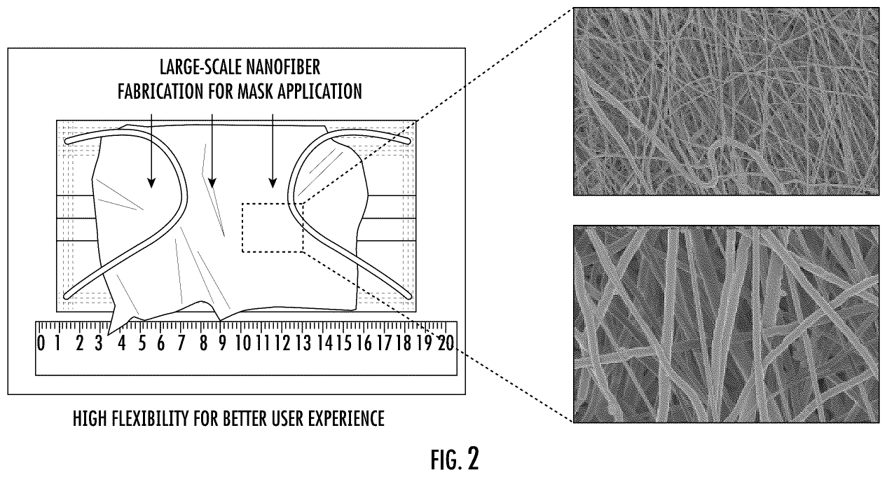

FIG. 2 illustrates examples of use of nanofibers in masks. Nanofiber portions of the mask are magnified on the right side of the figure. These constructions provide high flexibility for good user experience.

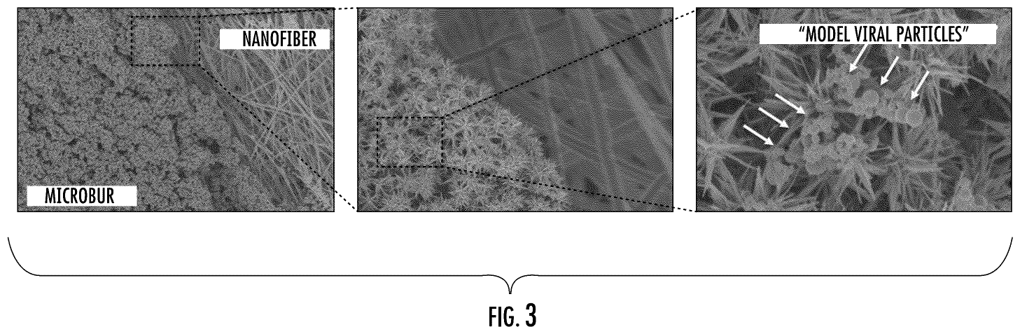

In FIG. 3, construction of a filter with adjacent layers of microfiber and Nanospiky particles is presented in the left image, a magnified view of the interface of the layers is presented in the middle image, and a magnified view of the Nanospiky particles with trapped model viral particles is presented in the right image.

Four examples of filter constructions are presented in Table 1 below. In this table, the MB refers to microbur with the composition of manganese dioxide with or without doping. The synthetic procedures are described above. In the MBAg-2h0x construct, the nanospiky particle is doped with silver. In the MB-2h-PEI construct (MB stands for microbur, 2h stands for the reaction time during microbur synthesis, PEI stands for polyethylenimine which is an exemplary coating that we used for modification of microbur). The nanospiky particle is coated with polyethylenimine (PEI).

Spikiness is controlled by varying the reaction time from 1, 2, 4 and 12 hours, which result in average spike numbers around 400, 250, 100, and 20 per microbur particle. In the table listed below, less spikes indicate spike number below 200 per particle. More spikes indicate spike number above 200 per particle.

| | Variable | | | |
|---|---|---|---|---|
| | #1 | Variable | Variable | |
| | Morphol- | #2 | #3 | Concen- |
| Construct | ogy | Composition | Coating | tration |
| MB-10 h-x | Less spikes | No doping | No coating | 5 mg/mL MB |
| MBAg-2 h0x | More spikes | Silver | No coating | 5 mg/mL MB |
| | | doping | | |
| MB-2 h-PEI | More spikes | No doping | PEI | 5 mg/mL MB |
| MB-2 h-x | More spikes | No doping | No coating | 5 mg/mL MB |

The present disclosure is not limited to the specific details of construction, arrangement of components, or method steps set forth herein. The compositions and methods disclosed herein are capable of being made, practiced, used, carried out and/or formed in various ways that will be apparent to one of skill in the art in light of the disclosure. The phraseology and terminology used herein is for the purpose of description only and should not be regarded as limiting to the scope of the claims. All methods described herein can be performed in any suitable order unless otherwise indicated herein or otherwise clearly contradicted by context.

The use of any and all examples, or exemplary language (e.g., “such as”) provided herein, is intended merely to facilitate the disclosure and does not imply any limitation on the scope of the disclosure unless otherwise claimed. No language in the specification, and no structures shown in the drawings, should be construed as indicating that any non-claimed element is essential to the practice of the disclosed subject matter. The use herein of the terms “including,” “comprising,” or “having,” and variations thereof, is meant to encompass the elements listed thereafter and equivalents thereof, as well as additional elements. Embodiments recited as “including, “comprising,” or “having” certain elements are also contemplated as “consisting essentially of” and “consisting of those certain elements.

It is to be understood that the compositions and methods for providing hybrid nanoporous membranes comprising a polymer layer and a 3D nanospiky particle layer for use in various filtration products are not limited to the specific embodiments described above, but encompass any and all embodiments within the scope of the generic language of the following claims enabled by the embodiments described herein, or otherwise shown in the drawings or described above in terms sufficient to enable one of ordinary skill in the art to make and use the claimed subject matter.

1. A hybrid nanoporous membrane comprising a polymer layer and a 3D nanospiky particle layer, the 3D nanospiky particle layer comprising particles comprising gold, silver, iron oxides, manganese oxides, titanium oxides, nickel, silica, silicon, zinc oxides, carbon, or any combination thereof.

2. The hybrid nanoporous membrane of claim 1, wherein the 3D nanospiky particle layer comprises manganese oxide, manganese dioxide, or a combination thereof.

3. The hybrid nanoporous membrane according to claim 1, wherein the polymer layer comprises nanofibers.

4. The hybrid nanoporous membrane according to claim 2, wherein the manganese oxide or manganese dioxide is silver-doped.

5. The hybrid nanoporous membrane according to claim 1, wherein the 3D nanospiky particles have 1-100 nm interstitial space.

6. The hybrid nanoporous membrane according to claim 1, wherein the 3D nanospiky particles comprise at least 4 spikes.

7. The hybrid nanoporous membrane according to claim 6, wherein the 3D nanospiky particles comprise over 5000 spikes.

8. The hybrid nanoporous membrane according to claim 1, wherein each spike ranges from 5 nm to 100 μm in length.

9. The hybrid nanoporous membrane according to claim 8, wherein the tip diameter of each spike ranges from 0.5 nm to 100 nm.

10. The hybrid nanoporous membrane of claim 1, wherein the polymer comprises one or more of polycaprolactone, poly lactic co-glycolic acid, chitosan, cellulose-derivatives, polytetrafluoroethylenes, nylon, and polycarbonates.

11. The hybrid nanoporous membrane of claim 1, wherein the membrane is useful for filtering or inhibiting one or more of the following: microorganisms, viruses, and other biological substances, or other environmental contaminants.

12. The hybrid nanoporous membrane of claim 11, wherein the one or more environmental or biological substances comprises one or more of the following: atmospheric aerosol particles, viruses, bacteria, fungi, extracellular vesicles, and cancer cells.

13. The hybrid nanoporous membrane of claim 12, wherein the membrane further comprises one or more active ingredients effective to neutralize or treat one or more of the environmental or biological substances.

14. A filtration device comprising the hybrid nanoporous membrane of claim 1.

15. The filtration device of claim 14, wherein the product comprises one or more of the following: a face mask or other air and fluid filters for filtering or inhibiting biological contaminants, an air pollution filter, a cell culture substrate, a wound dressing, a hemodialysis membrane, a gauze or scaffold used for organ transplantation with scavenging capability, a vessel graft, and a tumor insert.

16. A method of providing filtration comprising use of the hybrid nanoporous membrane of claim 1.

17. A method of providing filtration comprising use of the filtration device of claim 15.

18. A hybrid nanoporous membrane comprising a polymer layer and a 3D nanospiky particle layer, the 3D nanospiky particle layer comprising particles comprising manganese oxide, manganese dioxide, or a combination thereof,
wherein the polymer layer comprises nanofibers, and
wherein the manganese oxide, the manganese dioxide, or both, are silver-doped.

19. The hybrid nanoporous membrane of claim 18, wherein the 3D nanospiky particles comprise at least 4 spikes, each spike ranging from 5 nm to 100 μm in length, and
wherein the tip diameter of each spike ranges from 0.5 nm to 100 nm.

20. The hybrid nanoporous membrane of claim 18, wherein the polymer comprises one or more of polycaprolactone, poly lactic co-glycolic acid, chitosan, cellulose-derivatives, polytetrafluoroethylenes, nylon, and polycarbonates, and
wherein the membrane is useful for filtering or inhibiting one or more of the following: microorganisms, viruses, and other biological substances, or other environmental contaminants.
